(19) United States
(12) Patent Application Publication
(10) Pub. No.: US 2024/0246713 A1
(43) Pub. Date: Jul. 25, 2024

(54) SHAVING CARTRIDGE DISPENSER

(71) Applicant: The Gillette Company LLC, Boston, MA (US)

(72) Inventors: Kyra Cecelia Post, Cambridge, MA (US); Marc Philip Ortins, Reading, MA (US)

(21) Appl. No.: 18/100,155

(22) Filed: Jan. 23, 2023

(51) Int. Cl. B65D 1/36; B65D 77/20

(52) U.S. Cl. CPC B65D 1/36; B65D 77/2024; B26B 21/222

(57) ABSTRACT

A shaving cartridge dispenser having a formed container defining an enclosed storage region and having a rim around an entrance to the storage region. The formed container has an inner bottom wall and two opposed side walls. Each of the two side walls are connected by a front wall and a rear wall. The two opposed side walls each have an inner convex surface positioned between the rim and the inner bottom wall configured to engage a shaving razor cartridge.

### FIELD OF THE INVENTION

The present invention relates generally to dispensers for consumer products and more particularly, to dispensers for shaving razor cartridges.

### BACKGROUND OF THE INVENTION

In general, shaving razors of the wet shave type include a cartridge or blade unit with at least one blade with a cutting edge which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor).

Various types of protective covers have been utilized with commercially available razor cartridges. These covers may serve several purposes. First, the cover protects the razor cartridge and the blade edges during the different stages of shipping and retailing from forces which may damage the blade edges. Secondly, the cover also protects a user from unintentionally encountering the razor's sharp blade or blades when the razor is not in use. Furthermore, the cover may serve as a storage unit for the razor cartridge between shaves.

The covers which are currently available typically require a removal force in the direction of separation (i.e., the cover is either pulled or pushed directly off of the razor in the direction of the applied force). For some consumers, especially consumers that have always used a double edge razor without any protective cover, the removal of the cover is not intuitive. For example, the consumer may unintentionally remove the razor cartridge from the handle when removing the cover, which may damage the attachment mechanism of the shaving razor. The consumer may also may not understand the best way to hold or grip the dispenser so they do not cut themselves as they remove the cartridge from the dispenser.

Some cartridge dispensers may include compartments into which individual blade cartridges are stored, that have lugs or undercuts to maintain the cartridge(s) in the dispenser. A user may attach one end of the handle to the cartridge stored within the dispenser and pull up on the handle to overcome the force of the lug(s) or undercut(s) to remove the cartridge from the dispenser. The user can also place a used cartridge into an empty dispenser by pushing the used cartridge into the compartment, overcoming the force of the lug(s) or undercut(s) when pushing down, and then releasing the cartridge from the handle.

Consumers are starting to demand products and packages that are more sustainable, have less waste and a smaller environmental impact. However, shaving razor cartridge dispensers are most often formed of plastic and are rarely recycled by the consumer. Furthermore, sustainable materials are very limited as to design features that may be incorporated. For example, unlike plastic injection molded dispensers, pulp formed materials cannot be easily manufactured with cut outs, undercuts or lugs to retain the shaving razor cartridges.

Despite the use of known packaging techniques, there remains a need to further modify shaving razor cartridge dispensers to provide a dispenser that is sustainable and also conveniently and efficiently retains, dispenses and accepts shaving razor cartridges in a manner that is intuitive and easy to use for a consumer.

### SUMMARY OF THE INVENTION

In one aspect, the invention features, in general, a shaving cartridge dispenser having a formed container defining an enclosed storage region and having a rim around an entrance to the storage region. The formed container has an inner bottom wall and two opposed side walls. Each of the two side walls are connected by a front wall and a rear wall. The two opposed side walls each have an inner convex surface extending between the rim and the inner bottom wall configured to engage a shaving razor cartridge.

In another aspect, the invention features, in general, a shaving cartridge dispenser having a formed container defining an enclosed storage region and a rim around an entrance to the storage region. The formed container having an inner bottom wall connecting two opposed side walls. Each of the two side walls are connected by a front wall and a rear wall. The two opposed side walls each have an outer concave surface configured to receive a digit of a user. The outer concave surface of the two opposed side walls extend between the rim and an outer bottom wall.

### BRIEF DESCRIPTION OF THE DRAWINGS

FIG. 1 is a perspective view of one possible embodiment of a shaving razor cartridge package.

FIG. 2 is an assembly view of the shaving razor cartridge package of FIG. 1.

FIG. 3A is a first perspective view of a formed container of the shaving razor dispenser of FIG. 1.

FIG. 3B is a second perspective view of a formed container of the shaving razor dispenser of FIG. 1.

FIG. 4 is a bottom view of the formed container of FIGS. 3A and 3B.

FIG. 5 is a top view of the formed container of FIGS. 3A and 3B.

FIG. 6 is a cross section view of the formed container, taken generally along the line 6-6 of FIG. 1.

FIG. 7 is a cross section view of the formed container, taken generally along the line 7-7 of FIG. 1.

### DETAILED DESCRIPTION OF THE INVENTION

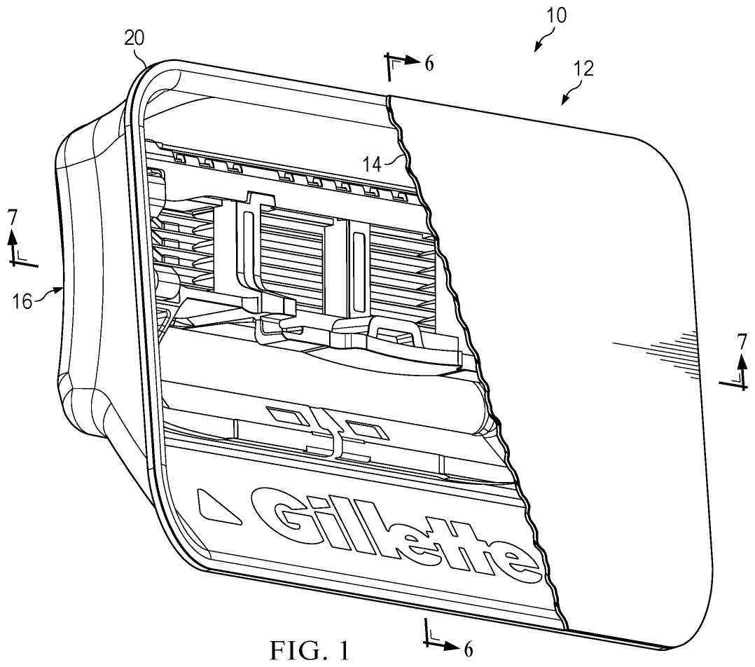

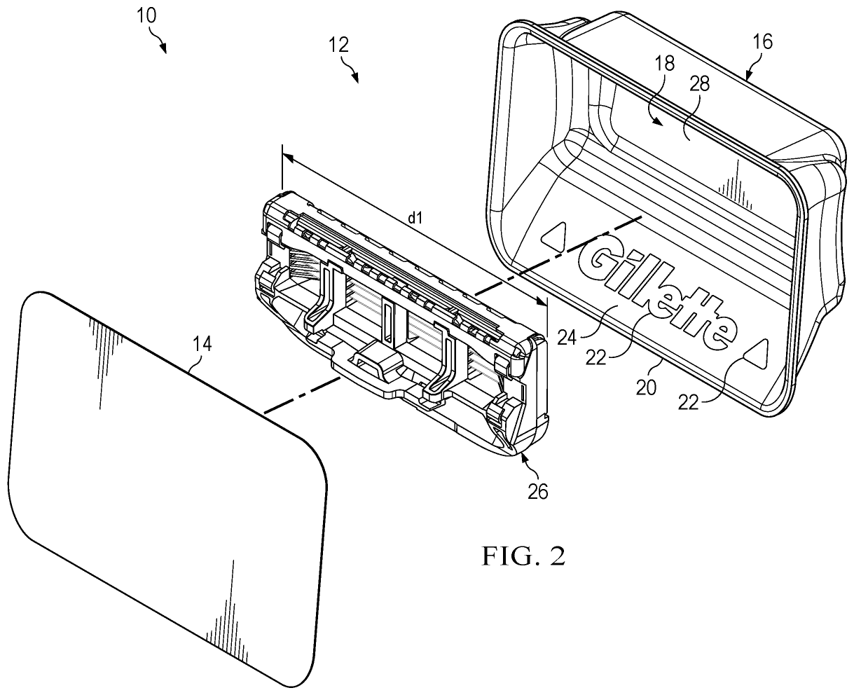

Referring to FIGS. 1 and 2, a perspective view and an assembly view of one possible embodiment of a shaving razor cartridge package 10 are illustrated, respectively. The shaving razor cartridge package 10 may include a shaving razor cartridge dispenser 12 with an optional lid 14. The shaving razor cartridge dispenser 12 may include a formed container 16 defining an enclosed region 18 having a rim 20 around an entrance to the enclosed storage region 18. The rim 20 may have many different configurations. For example, the rim 20 may include a flange, stepped surface, a rounded edge or a straight edge. The lid 14 may be sealed to the formed container 16 with a pressure sensitive adhesive or other conventional methods known to those skilled in the art. The shaving razor cartridge dispenser 14 may be interconnected to additional shaving razor cartridge dispensers 14 or manufactured as single unit.

The lid 14 and/or the formed container 16 may comprise one or more cellulose-based products such as cardboard, paperboard, paper sheet, bamboo and other sustainable, compostable, biodegradable or recycled/recyclable materials. The lid 14 and/or the formed container 16 may also be made from a slurry of water and pulp from fibrous materials, such as virgin pulp or recycled paper products, or other natural fibers (e.g., sugarcane, bamboo, wheat straw). The raw materials may help determine the color, surface texture and strength of the lid 14 and/or the formed container 16. The pulp may be formed into a shape by custom designed molds. The molds may be lowered into a pulp mixture and water pulled through a mesh of the mold with a vacuum. An upper part of the mold may press into the lower part of the mold to arrive at the final shape. The shaving razor cartridge dispenser 12 may be formed with numerous other processes, such as drawing, folding, stamping, molding, thermoforming, 3D printing, dry forming and wet forming. In certain embodiments, the lid 14 may comprise a different material than the formed container 16. For example, the lid 14 may include a polymer film that is sealed to the shaving razor cartridge dispenser 12, which can be peeled off to gain access to the enclosed region 18. In other embodiments, the lid 14 may be connected to the formed container 16 with a thin web of material to form a hinge.

In certain embodiments, the shaving razor cartridge dispenser 12 may include one or more branding logos and/or indicia 22 on an upper surface 24 of the formed container 16. The one or more branding logos and/or indicia 22 may be embedded in the upper surface 24 from a forming or molding process. Alternatively, the one or more branding logos and/or indicia 22 may be printed on the upper surface 24 either directly or with a label. The upper surface 24 may extend from the rim 20 toward the enclosed storage region 18.

The shaving razor cartridge dispenser 12 may include a shaving razor cartridge 26. A single shaving razor cartridge 26 may be positioned within the enclosed storage region 18 of the formed container 16. The shaving razor cartridge 26 may have an overall width of “d1”. The distance “d1” may be representative of commercially available shaving razor cartridges, for example, “d1” may be about 37 mm to about 52 mm. As will be explained in greater detail below, the shaving razor cartridge 26 may be retained within the enclosed storage region 18 by an interference fit created by the formed container 16. The shaving razor cartridge 26 may be retained so it does not become dislodged or fall out of the formed container 16 during handling and handling.

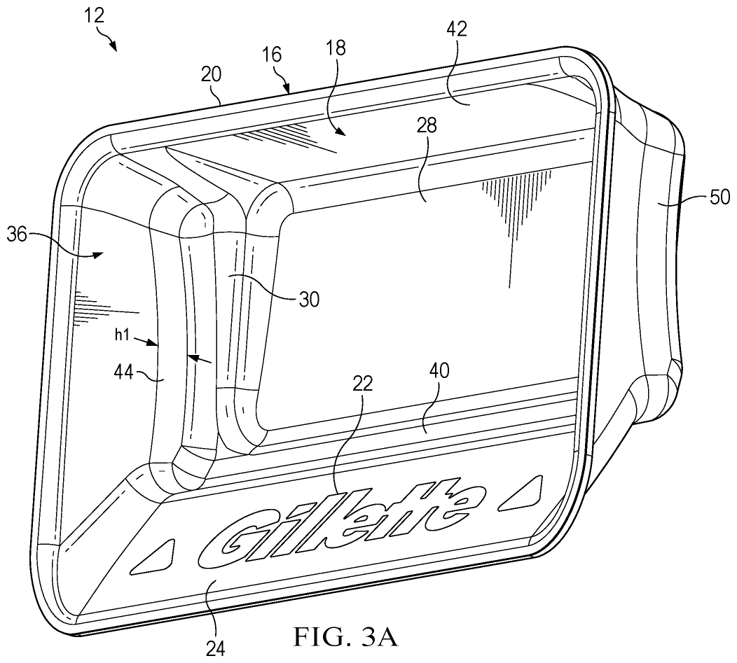

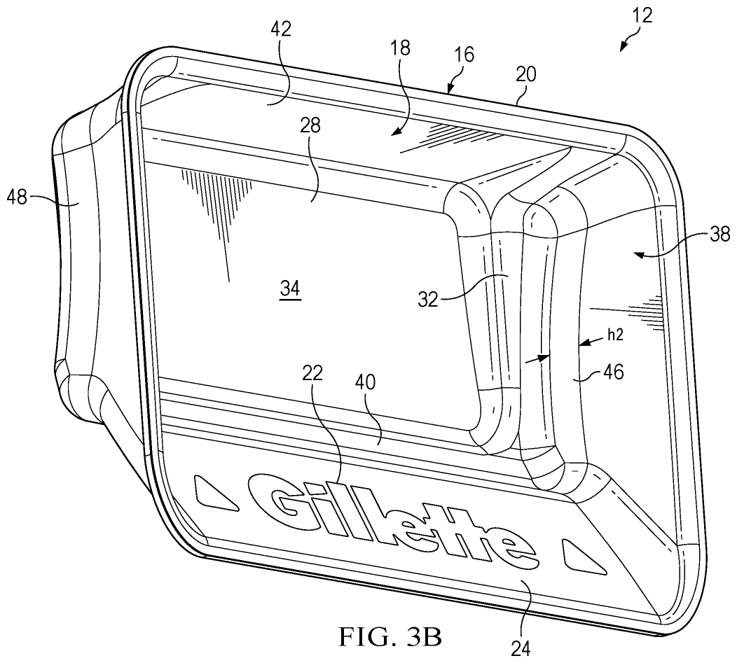

Referring to FIGS. 3A and 3B, a first and second side perspective view of the shaving razor cartridge dispenser 12 FIG. 1 is illustrated with the lid 14 removed for clarity. The shaving razor cartridge 26 of FIG. 1 has also been removed for clarity to better illustrate the formed container 16. The formed container 16 may have an inner bottom wall 28. In certain embodiments, the inner bottom wall 28 may include a pair of spaced apart support walls 30 and 32. The shaving razor cartridge 26 of FIG. 1 may rest on the pair of support walls 30 and 32 such that the shaving razor cartridge 26 of FIG. 1 is spaced apart from a portion 34 of the inner bottom wall 28 that extends between the pair of support walls 30 and 32. The spacing of the shaving razor cartridge 26 from the portion 34 of the inner bottom wall 28 may facilitate the drying of the shaving razor cartridge 26 after use. The spacing of the shaving razor cartridge 26 from the portion 34 of the inner bottom wall 28 may also help prevent a lubrication member of the shaving razor cartridge from bonding to the inner bottom wall 28. In certain embodiments, the portion 34 may be flat. However, it is understood, the portion 34 may include various textures.

The formed container 16 may include two opposed side walls 36 and 38. Each of the two side walls 36 and 38 may be connected by a front wall 40 and a rear wall 42. The two opposed side walls 36 and 38 may each have a respective inner convex surface 44 and 46 positioned between the rim 20 and the inner bottom wall 28, which may include the support walls 30 and 32. In certain embodiments, the inner convex surfaces 44 and 46 may have a respective height “h1” and “h2” of about 1 mm to about 10 mm and more preferably about 3 mm to about 6 mm. The heights h1 and h2 may vary depending on the size of a shaving razor cartridge to be held within the storage region 18. In certain embodiments, the inner convex surfaces 44 and 46 may extend the full height from the rim 20 to the inner bottom wall 28 to maximize retention of the shaving razor cartridge 26, thus providing a larger area to retain the shaving razor cartridge 26 of FIG. 1.

The inner convex surfaces 44 and 46 may serve to retain the shaving razor cartridge 26 of FIG. 1. Typical shaving razor cartridge dispensers utilize lugs or undercuts (e.g., snap fits); however these types of designs are not practical for manufacturing processes of sustainable materials (e.g., forming). Sustainable materials do not have similar properties to plastics which allow for the formation of various features by injection molding or thermoforming. The inner convex surfaces 44 and 46 may each have a radius of about 5 mm to about 35 mm and preferably about 10 mm to about 30 mm. If the radii are too small there may not be sufficient engagement between the convex surfaces 44 and 46 and the shaving razor cartridge 26 (FIGS. 1 and 2). In addition, if the radii are too large or even a straight or flat surface, tolerancing the proper interference between the convex surfaces 44 and 46 and the shaving razor cartridge 26 (FIGS. 1 and 2) may be difficult. For example, small dimensional changes may result in a fit that is too tight or too loose.

As will be described in greater detail below, the shaving razor cartridge 26 of FIG. 1 may be positioned within the storage region 18, such that the shaving razor cartridge 26 contacts the inner convex surfaces 44 and 46, deflecting the inner convex surfaces 44 and 46 in an outward direction. In certain embodiments, the convex surfaces 44 and 46 may undergo permanent deformation. In other embodiments, the convex surfaces 44 and 46 may temporarily deform so the convex surfaces 44 and 46 are able to retain the shaving cartridge 26 even after the shaving cartridge 26 has been inserted and removed from the formed container 16 multiple times.

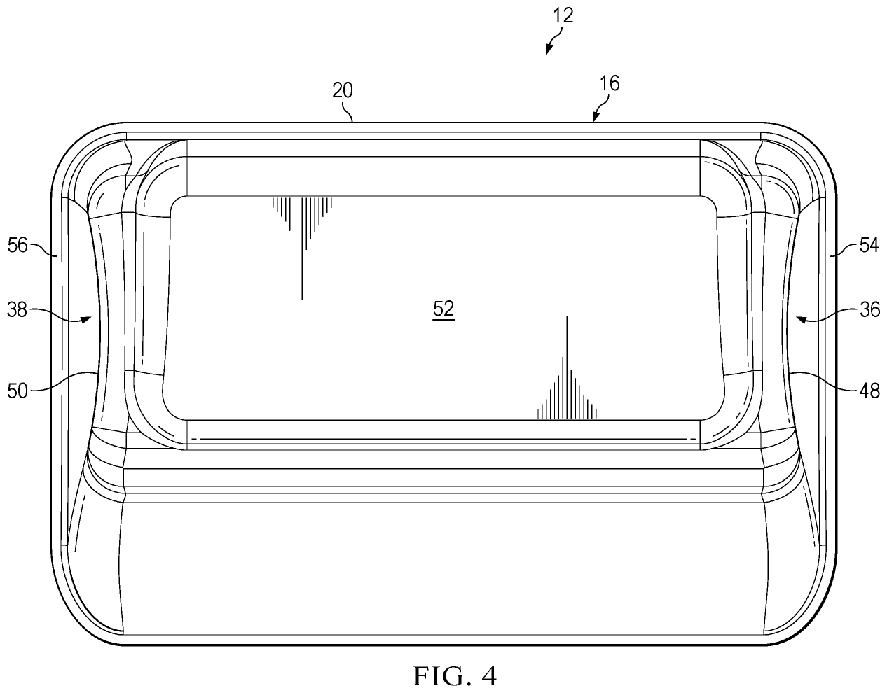

As shown in FIGS. 3A, 3B and 4, the two opposed side walls 36 and 38 may each have a respective outer concave surface 48 and 50 that extend between the rim 20 and an outer bottom wall 52 (FIG. 4). Accordingly, the two opposed side walls 36 and 38 may serve a dual function by not only retaining the shaving razor cartridge 26 of FIG. 1, but also providing an intuitive gripping region for a consumer to hold the shaving razor cartridge dispenser 12 as they are inserting and removing the shaving razor cartridge 26. In certain embodiments, the outer concave surfaces 48 and 50 may correspond to the inner convex surfaces 44 and 46. For example, a radius of the outer concave surfaces 48 and 50 may match a radius of the corresponding inner convex surfaces 44 and 46. The outer concave surfaces 48 and 50 may each have a radius of about 5 mm to about 35 mm and preferably about 10 mm to about 30 mm. The outer convex surfaces 44 and 46 may be textured or have protrusions to improve grip an provide a visual indicia for the consumer to hold the shaving razor cartridge dispenser 12. The outer concave surfaces 48 and 50 may extend continuously from the rim 20 to the outer bottom wall 52. The outer concave surfaces 48 and 50 may each have a single radius. In certain embodiments, the outer concave surfaces 48 and 50 may have a respective height “h3” and “h4” of about 3 mm to about 20 mm and more preferably about 3 mm to about 10 mm. In certain embodiments, the outer concave surfaces 48 and 50 may extend from the rim 20 toward the outer bottom wall 52. In other embodiments, the outer concave surfaces 48 and 50 may extend the full height from the rim 20 to the outer bottom wall 52 to provide a larger area for a consumer to hold the shaving razor cartridge dispenser 12 with their digits.

A user may grip the outer concave surfaces 48 and 50 of the side walls 36 and 38 and engage one end of a handle (not shown) with the shaving razor cartridge 26 positioned within the storage region of the formed container 16. The user may then pull up on the handle to overcome the force of the inner convex surfaces 44 and 36 to remove the cartridge from the dispenser. The user can also place the shaving razor cartridge 26 back into the shaving razor cartridge dispenser 12 after use by inserting it into the enclosed region 18 to overcome the force of the inner convex surfaces 44 and 36 when pushing down, and then releasing the shaving razor cartridge 26 from the handle.

In certain embodiments, the formed container 16 may include a first flat flange surface 54 between the outer concave surface 48 and the rim 20 and a second flat flange surface 56 between the outer concave surface 50 and the rim 20. The first and second flat flange surfaces 54 and 56 may facilitate the placement of a user's digits when they are holding the shaving cartridge dispenser 12. For example, the first and second flat flange surfaces 54 and 56 may help keep a user's digits from interfering with insertion and removal of the shaving razor cartridge 26 (FIG. 2) by keeping the user's digits from extending over the rim 20 and the enclosed region 18.

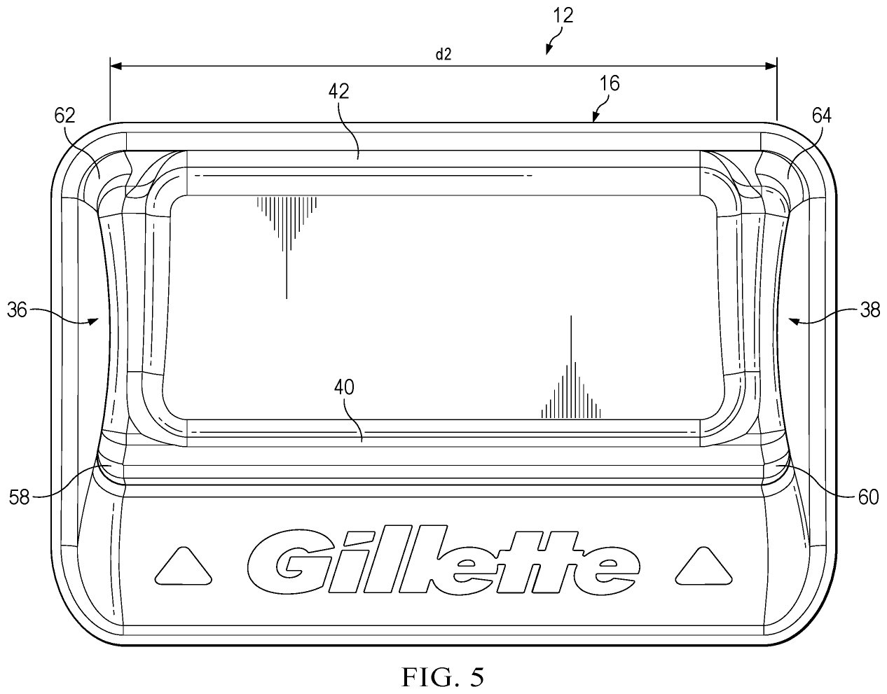

Referring to FIG. 5, a top view of the shaving razor cartridge dispenser 12 is illustrated. In certain embodiments, a distance “d2” between the inner convex surfaces 44 and 46 may be slightly smaller than “d1” (FIG. 2). For example, the distance “d2” between the inner convex surfaces 44 and 46 may be less than the distance “d1” of the overall width of the shaving razor cartridge 26 (FIG. 2) by about 0.25 mm to about 5.0 mm and more preferably about 0.75 mm to about 2.0 mm total interference, to create an interference fit for holding the shaving razor cartridge 26 (FIG. 2) in place. A first pair of inner concave surfaces 58 and 60 may connect the front wall 40 to the pair of opposing side walls 36 and 38. A second pair of inner concave surfaces 62 and 64 may connect the rear wall 42 to the pair of opposing side walls 36 and 38. The first pair of inner concave surfaces 58 and 60 and the second pair of inner concave surfaces 62 and 64 may each have a radius of about 1.0 mm to about 5.0 mm and preferably about 2.0 mm to about 4.0 mm to help prevent tearing or weakening of the formed container 16 during manufacturing (e.g., dry or wet forming).

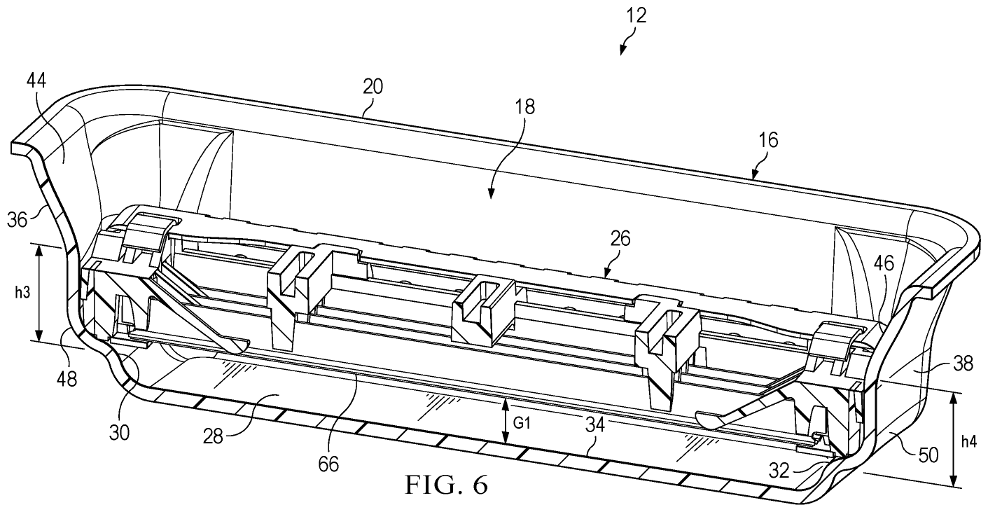

Referring to FIG. 6, a cross sectional view of the shaving razor cartridge dispenser 12, taken generally along the line 6-6 of FIG. 1. The lid 14 has been removed for clarity. The shaving razor cartridge 26 may be positioned within the enclosed region 18 of the formed container 16. The shaving razor cartridge 26 may engage the inner convex surfaces 44 and 46 of the respective side walls 36 and 38. The inner convex surfaces 44 and 46 may deflect to retain the shaving razor cartridge 26. In certain embodiments, the shaving razor cartridge 26 may permanently deform the inner convex surfaces 44 and 46, depending on the material of the formed container 16, stress levels applied and the length of time the shaving razor cartridge 26 is retained between the inner convex surfaces 44 and 46. However, it is understood that the inner convex surfaces 44 and 46 may also have an elastic deformation component to allow the shaving razor cartridge 26 to still be retained between the inner convex surfaces 44 and 46 even after several cycles of insertion and removal. The shaving razor cartridge 26 may push again the inner convex surfaces 44 and 46 such that they may no longer be convex while the shaving razor cartridge 26 is held in place. The inner convex surfaces 44 and 46 may return to a generally convex shape after the shaving razor cartridge 26 is removed.

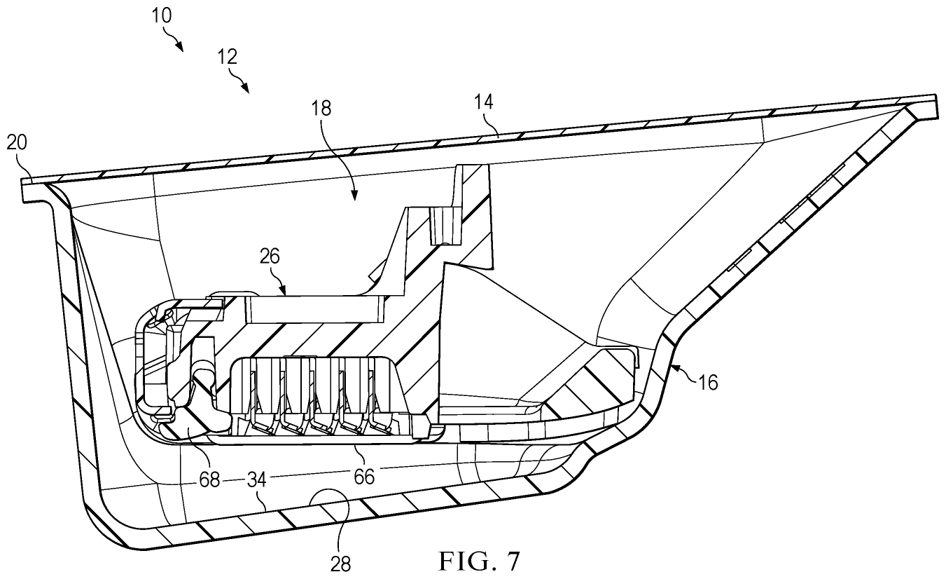

Referring to FIG. 7, a cross section view of the shaving razor cartridge package 10, taken generally along the line 7-7 of FIG. 1. The shaving razor cartridge 26 may be positioned within the enclosed storage region 18 of the formed container 16 such the shaving razor cartridge 26 rests on the support walls 30 and 32 (FIG. 6). A bottom surface 66 of the shaving razor cartridge 26 may be spaced apart from the portion 34 of the inner bottom wall 28 that extends between the pair of support walls 30 and 32 (FIG. 6). Accordingly, there may be a gap “G1” between the shaving razor cartridge 26 and the portion 34 of the inner bottom wall 28, as shown in FIG. 6. The gap “G1” may be about 0.5 mm to about 5 mm to allow for improved drying of the shaving razor cartridge 26 after use. The gap “G1” may also help prevent bridging which may occur between a lubrication member 68 (as shown in FIG. 7) on the shaving razor cartridge 26 and the inner bottom wall 28, which can cause the lubrication member 68 to adhere to the inner bottom wall 28.

The lid 14 may be mounted to the rim 20 of the formed container 16. In certain embodiments, the lid 14 may be pressed fitted to the formed container 16 to allow for easy removal. In other embodiments, the lid 14 may be fixed to the formed container 16 (e.g., the rim 20) with a pressure sensitive adhesive or other conventional methods known to those skilled in the art.

The dimensions and values disclosed herein are not to be understood as being strictly limited to the exact numerical values recited. Instead, unless otherwise specified, each such dimension is intended to mean both the recited value and a functionally equivalent range surrounding that value. Dimensions should not be held to an impossibly high standard of metaphysical identity that does not allow for discrepancies due to typical manufacturing and measuring tolerances. Therefore, the term “about” should be interpreted as being within typical manufacturing and measuring tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge dispenser comprising:
a formed container defining an enclosed storage region and having a rim around an entrance to the storage region, the formed container having an inner bottom wall connecting two opposed side walls, each of the two side walls connected by a front wall and a rear wall, wherein, the two opposed side walls each have an inner convex surface positioned between the rim and the inner bottom wall configured to engage a shaving razor cartridge.

2. The shaving cartridge dispenser of claim 1 further comprising a pair of spaced apart support walls extending from the inner bottom wall.

3. The shaving cartridge dispenser of claim 1 wherein each of the inner convex surfaces has a radius of about 5 mm to about 35 mm.

4. The shaving cartridge dispenser of claim 1 wherein the formed container includes a first pair of inner concave surfaces connecting the front wall to the pair of opposing side walls.

5. The shaving cartridge dispenser of claim 4 wherein the formed container includes a second pair of inner concave surfaces connecting the rear wall to the pair of opposing side walls.

6. The shaving cartridge dispenser of claim 5 wherein the first pair of inner concave surfaces and the second pair of concave inner surfaces each have a radius of about 1 mm to about 5 mm.

7. The shaving cartridge dispenser of claim 1 further comprising a lid mounted to the rim.

8. The shaving cartridge dispenser of claim 1 wherein each of the two opposing side walls has an outer concave surface extending between the rim and an outer bottom wall configured to receive a digit of a user.

9. The shaving cartridge dispenser of claim 1 wherein the outer concave surfaces of the two opposing side walls have a radius of about 5 mm to about 35 mm.

10. The shaving cartridge dispenser of claim 1 further comprising a shaving razor cartridge positioned within the storage region, wherein the shaving razor cartridge contacts the inner convex surfaces, deflecting the inner convex surfaces in an outward direction.

11. The shaving cartridge dispenser of claim 10 wherein the shaving razor cartridge permanently deforms the inner convex surfaces.

12. The shaving cartridge dispenser of claim 11 further comprising a pair of support walls extending from the inner bottom wall, wherein the shaving razor cartridge rests on the pair of support walls and the shaving razor cartridge is spaced apart from a portion of the inner bottom wall that extends between the pair of support walls.

13. The shaving cartridge dispenser of claim 12 wherein the portion is flat.

14. The shaving cartridge dispenser of claim 1 wherein the container is formed from a pulp material.

15. A shaving cartridge dispenser comprising:
a formed container defining an enclosed storage region and having a rim around an entrance to the storage region, the formed container having an inner bottom wall connecting two opposed side walls, each of the two side walls connected by a front wall and a rear wall wherein, the two opposed side walls each have an outer concave surface configured to receive a digit of a user, the outer concave surface of the two opposed side walls extending between the rim and an outer bottom wall.

16. The shaving cartridge dispenser of claim 15 further comprising a first pair of inner concave surfaces connecting the front wall to the pair of opposing side walls.

17. The shaving cartridge dispenser of claim 16 further comprising a second pair of outer concave surfaces connecting the rear wall to the pair of opposing side walls.

18. The shaving cartridge dispenser of claim 17 wherein the first pair of inner concave side walls and the second pair of concave inner side walls each have a radius of about 1 mm to about 5 mm.

19. The shaving cartridge dispenser of claim 16 wherein each of the outer concave surfaces have a corresponding inner convex surface.

20. The shaving cartridge dispenser of claim 19 wherein each of the outer concave surfaces have a height of about 3 mm to about 6 mm and each of the inner convex surfaces have a height of about 3 mm to about 6 mm.
